(19) United States
(12) Patent Application Publication
(10) Pub. No.: US 2007/0257882 A1
(43) Pub. Date: Nov. 8, 2007

(54) Magnetic induction cursor input system

(76) Inventor: Huo-Lu Tsai, Taichung Hsien (TW)

Correspondence Address: Huo-Lu Tsai;235 Chung - Ho, Box 8-24, Taipei, TW

(21) Appl. No.: 11/416,442

(22) Filed: May 3, 2006

(51) Int. Cl. G09G 5/08

(52) U.S. Cl. 345/157

(57) ABSTRACT

A magnetic induction cursor input system comprises a movable magnetic body; a first coordinate induction coil; a first oscillating circuit module electrically connected to the first coordinate induction coil; a first monitoring and period calculation module electrically connected to the first oscillating circuit module; a processor electrically connected to the first monitoring and period calculation module; an output end connected to the processor; a rotatable magnetic body rotatable along a rotation axle at a second direction; a second coordinate induction coil; a second oscillating circuit module electrically connected to the second coordinate induction coil; a second monitoring and period calculation module electrically connected to the second oscillating circuit module and also connected to the processor. The movable magnetic body is moveable in a first direction; and rotation of the second coordinate induction coil will interfere the magnetic field of the second coordinate induction coil.

### FIELD OF THE INVENTION

The present invention relates to cursors, and in particular to a magnetic induction cursor input system, wherein a movable magnetic body and a rotatable magnetic body serve to change the inductance of a coil. The variation of the inductance is detected by an oscillating circuit modules, which is then converted as frequency change of the oscillating circuit so as to get the movement of the speed and direction of a cursor in a screen.

### BACKGROUND OF THE INVENTION

Mice of computer devices are used to control the movements of cursors on the screens. The control of mouse is suitable for the human sense in operation. The clicking operation is suitable for the thought of the human brain. However although the operation of mouse has provided some advantages to human, but it occupies a greater space in a table. Thereby the operator must move away from the keyboard for operating the mouse.

Some other devices, such as tracking balls, touch plates, controlling rods, touch screens, etc., are developed to replace the computer mouse. However the operation of controlling rods and touch screens still causes that the hand must leave from the keyboard. The track ball and touch plate generally could be combined with a keyboard, but the uses of theses devices are not convenient.

The prior art cursor control device can be classified as mechanic devices and photoelectric devices. The structure is complicated and the cost is high.

### SUMMARY OF THE INVENTION

Accordingly, the primary object of the present invention is to provide a magnetic induction cursor input system, wherein a movable magnetic body and a rotatable magnetic body serve to change the inductance of a coil. The variation of the inductance is detected by the oscillating circuit modules, which is then converted as frequency change of the oscillating circuit. The monitoring and period calculation module serves to calculate this variation and then transfers to the processor. The processor 50 converts the frequency variation into the speed and direction of the cursor movement. Then the results are outputted by the output end to a cursor interface of an electronic device so as to achieve the object of cursor control.

To achieve above objects, the present invention provides a magnetic induction cursor input system which comprises a movable magnetic body; a first coordinate induction coil; a first oscillating circuit module electrically connected to the first coordinate induction coil; a first monitoring and period calculation module electrically connected to the first oscillating circuit module; a processor electrically connected to the first monitoring and period calculation module; an output end connected to the processor; a rotatable magnetic body rotatable along a rotation axle at a second direction; a second coordinate induction coil; a second oscillating circuit module electrically connected to the second coordinate induction coil; a second monitoring and period calculation module electrically connected to the second oscillating circuit module and also connected to the processor. The movable magnetic body is moveable in a first direction; and rotation of the second coordinate induction coil will interfere the magnetic field of the second coordinate induction coil.

The various objects and advantages of the present invention will be more readily understood from the following detailed description when read in conjunction with the appended drawing.

### BRIEF DESCRIPTION OF THE DRAWINGS

FIG. 1 is a functional block diagram of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

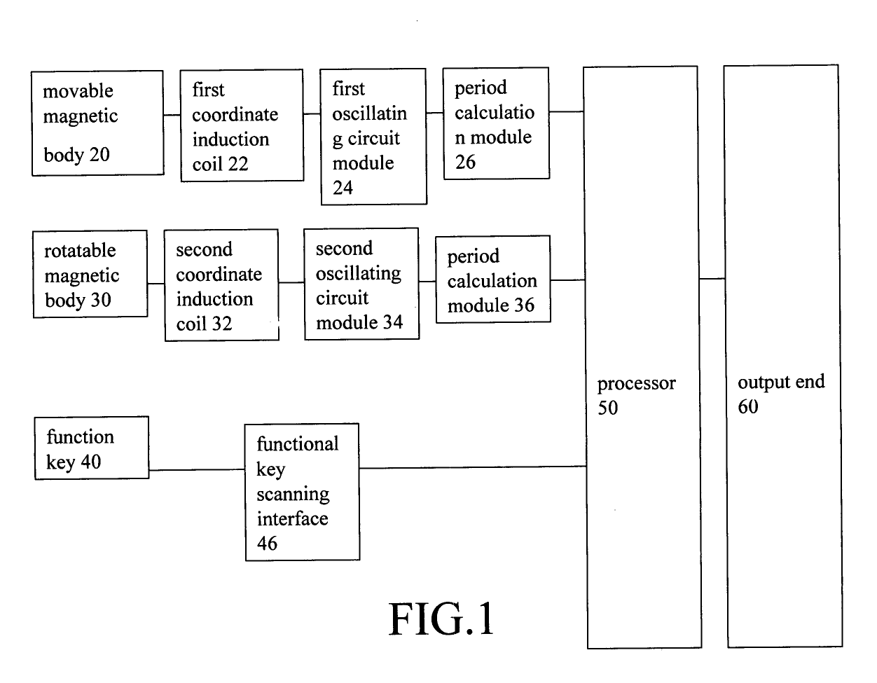

Referring to FIG. 1, the magnetic induction cursor input system of present invention is illustrated. The present invention has the following elements.

A movable magnetic body 20

A first coordinate induction coil 22 is included.

A first oscillating circuit module 24 is electrically connected to the first coordinate induction coil 22.

A first monitoring and period calculation module 26 is electrically connected to the first oscillating circuit module 24.

A processor 50 is electrically connected to the first monitoring and period calculation module 26.

An output end 60 is connected to the processor 50.

The movable magnetic body 20 is insertable into and moveable in the first coordinate induction coil 22 along a first direction to change the current in the first coordinate induction coil 22 and change the output frequency of the first oscillating circuit module 24. The first monitoring and period calculation module 26 calculates the variation of the frequency. Then the processor 50 calculates the moving direction and speed of the cursor. The output end 60 serves to output to a cursor interface of a calculator or other electronic devices so as to get the movement of the cursor along the first direction.

A rotatable magnetic body 30 can rotate along a rotation axle arranged along second direction. The rotation axle is distant to the second coordinate induction coil 32 with a fixed distance. When the rotatable magnetic body 30 rotates around the rotation axle. The magnetic field of the second coordinate induction coil 32 varies continuously. The variation of the magnetic field may be uniform or not uniform.

A second coordinate induction coil 32 is included.

A second oscillating circuit module 34 is electrically connected to the second coordinate induction coil 32.

A second monitoring and period calculation module 36 is electrically connected to the second oscillating circuit module 34 and is also connected to the processor 50.

The rotation of the second coordinate induction coil 32 will interfere the magnetic field of the second coordinate induction coil 32 so as to change the induced current of the second coordinate induction coil 32 to change the current in the second coordinate induction coil 32 and change the output frequency of the second oscillating circuit module 34. The second monitoring and period calculation module 36 calculates the variation of the frequency. Then the processor 50 calculates the moving direction and speed of the cursor. The output end 60 serves to output to a cursor interface of a calculator or other electronic devices so as to get the movement of the cursor along the second direction.

The first oscillating circuit module 24, first monitoring and period calculation module 26, second oscillating circuit module 34, second monitoring and period calculation module 36, processor 50 and output end 60 are known in the prior arts.

The designs of the movable magnetic body 20, first coordinate induction coil 22, rotatable magnetic body 30 and the second coordinate induction coil 32 will be described herein.

In one embodiment, the movable magnetic body 20 is formed by a magnetic sleeve installed to and movable to a core shaft. The first coordinate induction coil 22 encloses an outer periphery of the sleeve. An inner surface of the first coordinate induction coil 22 is retained with a distance to an outer surface of the sleeve. The rotatable magnetic body 30 is a magnetic sleeve installed to and rotatable to another core shaft. The radial thickness of the sleeve is varied so as to have a shape as a cam. The second coordinate induction coil 32 is installed at a circumferential periphery of the magnetic sleeve. Thereby when the magnetic sleeve rotates, the magnetic field will vary so as to interfere the magnetic field of the second coordinate induction coil 32.

The present invention further comprises a functional key 40 and a functional key scanning interface 46 electrically connected to the function key 40. The functional key scanning interface 46 is electrically connected to the processor 50. The function key 40 and functional key scanning interface 46 are known in the prior art and thus the details will be not further herein. By the function key 40 and functional key scanning interface 46, the trigger function of a mouse can be realized.

In the magnetic induction cursor input system of the present invention, the movable magnetic body 20 or the rotatable magnetic body 30 serves to change the inductance of a coil. The variation of the inductance is detected by the oscillating circuit modules, which is then converted as frequency change of the oscillating circuit. The monitoring and period calculation module serves to calculate this variation and then transfers to the processor 50. The processor 50 converts the frequency variation into the speed and direction of the cursor movement. Then the results are outputted by the output end to a cursor interface of an electronic device so as to achieve the object of cursor control. The present invention can be installed on a keyboard so that it can be used conveniently.

The element of the present invention is simple and low cost.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A magnetic induction cursor input system comprising:
a movable magnetic body;
a first coordinate induction coil;
a first oscillating circuit module electrically connected to the first coordinate induction coil;
a first monitoring and period calculation module electrically connected to the first oscillating circuit module;
a processor electrically connected to the first monitoring and period calculation module;
an output end connected to the processor;
a rotatable magnetic body rotatable along a rotation axle at a second direction;
a second coordinate induction coil;
a second oscillating circuit module electrically connected to the second coordinate induction coil;
a second monitoring and period calculation module electrically connected to the second oscillating circuit module and also connected to the processor.
wherein the movable magnetic body is moveable in a first direction to change the current in the first coordinate induction coil; and rotation of the second coordinate induction coil will interfere the magnetic field of the second coordinate induction coil so as to change the induced current of the second coordinate induction coil.

2. The magnetic induction cursor input system as claimed in claim 1, wherein the movable magnetic body is insertable into and moveable in the first coordinate induction coil along a first direction to change the current in the first coordinate induction coil and change output frequencies of the first oscillating circuit module.

3. The magnetic induction cursor input system as claimed in claim 2, wherein an insertion length of the movable magnetic body in the first coordinate induction coil will determine the current of the first coordinate induction coil.

4. The magnetic induction cursor input system as claimed in claim 1, wherein the rotatable magnetic body rotates along a rotation axle arranged along a second direction; and the rotation axle is distant to the second coordinate induction coil with a fixed distance.

5. The magnetic induction cursor input system as claimed in claim 4, wherein when the rotatable magnetic body rotates around the rotation axle; the magnetic field of the second coordinate induction coil varies continuously.

6. The magnetic induction cursor input system as claimed in claim 1, wherein the movable magnetic body is insertable into and moveable in the first coordinate induction coil along a first direction to change the current in the first coordinate induction coil and change output frequencies of the first oscillating circuit module; the first monitoring and period calculation module calculates the variation of the frequency; then the processor calculates the moving direction and speed of the cursor; the output end serves to output to a cursor interface of a calculator or other electronic devices so as to get the movement of the cursor along the first direction.

7. The magnetic induction cursor input system as claimed in claim 1, wherein wherein rotation of the second coordinate induction coil will interfere the magnetic field of the second coordinate induction coil so as to change induced currents of the second coordinate induction coil to change the current in the second coordinate induction coil and change the output frequency of the second oscillating circuit module; the second monitoring and period calculation module calculates the variation of the frequency; then the processor calculates the moving direction and speed of the cursor; the output end serves to output to a cursor interface of a calculator or other electronic devices so as to get the movement of the cursor along the second direction.

8. The magnetic induction cursor input system as claimed in claim 1, wherein the movable magnetic body is formed by a magnetic sleeve installed to and movable to a core shaft; the first coordinate induction coil encloses an outer periphery of the sleeve; and an inner surface of the first coordinate induction coil is retained with a distance to an outer surface of the sleeve.

9. The magnetic induction cursor input system as claimed in claim 1, wherein the rotatable magnetic body is a magnetic sleeve installed to and rotatable to another core shaft; the radial thickness of the sleeve is varied so as to have a shape as a cam; and the second coordinate induction coil is installed at a circumferential periphery of the magnetic sleeve.

10. The magnetic induction cursor input system as claimed in claim 1, further comprising a functional key and a functional key scanning interface electrically connected to the function key; wherein the functional key scanning interface is electrically connected to the processor.
